(19) United States
(12) Patent Application Publication
(10) Pub. No.: US 2010/0011972 A1
(43) Pub. Date: Jan. 21, 2010

(54) Thaw plate system

(76) Inventor: Alexander Joseph Kalogroulis, Coulsdon (GB)

Correspondence Address: CURTIS L. HARRINGTON, 6300 STATE UNIVERSITY DRIVE, SUITE 250, LONG BEACH, CA, 90815, US

(21) Appl. No.: 12/218,866

(22) Filed: Jul. 17, 2008

(51) Int. Cl. A23L 3/36; F28D 15/00

(52) U.S. Cl. 99/483; 165/104.31

(57) ABSTRACT

A thaw plate has a separate, self support motor unit which has an air exhaust which can be brought into proximity of an inlet opening of a plate support tray to cause air to flow underneath a thermal conduction plate in a manner that will cause thawing to occur. In a first embodiment a battery powered fan will cool the bottom of a thaw plate. The use of a fan to cause air to sweep across the bottom of the conduction plate will insure that enough flow will be present that the plate will not sweat or freeze. A second embodiment includes an air density chimney will be used to passively create a stream of air which will sweep a thermal conduction plate to create a warm air flow to enhance the thawing process in proportion to the difference in temperature between the thawing masses and the room temperature air.

### FIELD OF THE INVENTION

The present invention relates to an improvements in providing a safe, effective, low cost device and method for thawing food which will enhance the consistency and flavor of the food while reducing the time before cooking to a minimum safe time based upon ambient air, and more particularly to a safe, low energy, battery operated device which is safe to use, can be left unattended and which enables the user to depend upon it in lieu of taking a quick action for thawing which can ruin the food.

### BACKGROUND OF THE INVENTION

Cooks frequently freeze food, or buy frozen food, to greatly extend the period before which it becomes unsafe for consumption. Shoppers often buy food frozen for immediate preparation and consumption. The maintenance of a stock of frozen food also allows grocery stores and domestic and professional cooks great flexibility in what they will prepare for consumption on a daily basis. However there is a temporal bottleneck in this process as most frozen food needs to be defrosted before it can be cooked.

The defrosting operation is typically carried out by leaving the frozen food in the refrigerator for 24 hours or less in order to more gradually enable it to thaw evenly. This method is generally recommended as it keeps the food at a temperature at which bacteria do not thrive. Another method is to leave the frozen food on a counter top at room temperature for a few hours during which time the ambient heat energy is transferred from the room air at its temperature and humidity, directly into the frozen food.

This method of thawing is disadvantageous as it is slow, causing the user to place the food at room temperature for a long time before cooking, because preparers are typically more worried about not having the food thawed in time more than they worry about the possibility that the food is exposed to room temperature for an extended time. This can allow the frozen food to quickly and for too long a time attain a temperature at which bacteria thrive and multiply rapidly. This can result in food poisoning. A further method is to use a thaw plate that accelerates the transfer of heat energy by conduction, but conventional thaw plates have some limitations.

Conversely, where a food preparer puts the food out to thaw over too short a time period, the food mass might remain frozen in the middle, a condition which is more likely to happen if a cold spot exists underneath the food. The outside of the food, sides and top may seem perfectly thawed. Cooking the food while in this condition may produce top and sides which are perfectly done but a significant volume within the food mass which is raw and can cause parasites and disease if the food is consumed. Thawing food left on a surface will give no outward indication that a significant mass is still frozen unless it is probed and its temperature measured throughout, which is impractical an onerous. Further, if the food has a significant volume which is still not thawed, and if the cooking process is on a deadline, a bad result will occur in any event. Either the food will be cut up to free the thawed parts, or the food will be cooked anyway, which is dangerous.

Generally, heat transfer by conduction between the thaw plate and the mass of frozen food (heat transfer) is governed by three variables; the temperature differential between the common surfaces, the area of the surface and the coefficient of heat transfer between surfaces. To maximize heat transfer, all three variables can be increased, by increasing the temperature differential must, increasing the surface area, and optimizing the pairs of materials selected as having a high coefficient of heat transfer.

Furthermore, where a thaw plate of large surface area is utilized, it is advantageous to use a material of high thermal conductivity and adequate cross section to speed the transfer of heat energy from areas of high temperature (edges furthest from frozen food) to areas of low temperature (areas in contact with frozen food). Thaw plates are commonly used in the kitchen to accelerate the rate of thawing of a piece of frozen food, commonly cuts of meat such as steaks. Conventional thaw plates are typically metal sheets that are placed on a counter top with the frozen food being placed on top of the thaw plates. Heat energy flows from the metal plate into the frozen food due to the high differential temperature, at the junction of the food/metal interface and the contact and coefficient of heat transfer between the two. (This contact and coefficient of heat transfer can be generally improved as soon as some thawed liquid or condensed water wicks into the gaps between the surfaces of the thaw plate and frozen food mass).

This flow of heat energy reduces the temperature of the metal plate resulting in a difference in temperature between the ambient air and the metal plate, also known as ΔT. As a result, heat energy flows from the ambient air into the metal plate. If the ambient air is treated as an infinite source of heat energy it can be seen that there is a flow of heat energy from the ambient air into the frozen food. Because the flow of heat energy from the air into any solid material is greatly limited by the coefficient of heat transfer from air, it is advantageous to present as large a surface as possible to the air, given that the heat transfer through metal is significantly higher.

One drawback of conventional thaw plates is that they rapidly develop a cold spot below the location where the thawing mass is placed. This is particularly true where the frozen food is placed centrally or evenly on the thaw plate. The “cold spot” is due to the fact that the heat from the surrounding parts of the plate cannot flow fasten enough into the thawing mass. The result is that the cold air remains trapped beneath the thaw plate thereby reducing the differential temperature between the ambient air and the thaw plate over most of the underside of the thaw plate. This has a great effect on reducing the effectiveness of conventional thaw plates. Further, where a cold spot develops, it pulls moisture from the air. If the cold spot is cold enough, it will form ice crystals and continue to collect moisture from the air. Upon eventual thawing, it releases this water into a puddle on the surface supporting the thaw plate. Where the cold spot is not cold enough to form ice crystals, the thaw plate will continually “sweat” or drip onto the surface supporting the support table.

As by example, a standard approach thaw plate can be seen in U.S. Pat. No. 5,349,899. A lower surface of a plate made of material with a well heat transfer characteristics such as pure aluminum or aluminum alloy is provided with a plurality of heat radiation fins and further with legs in order to provide a natural thawing pan capable of slightly shorter thawing time with respect to that of the earlier prior art. This type of product that allows pools of cold air to collect below the thaw plate.

A Japan Patent Reference No. JP6153887 to Fujita Seiichiro on Mar. 6, 1994 disclosed a complete cabinet with a motor located below a thaw plate and which draws air from the inside and into the cabinet and passes it over a barrier which lies underneath a thaw plate. This device does not have a thaw plate support which can be disassembled for storage apart from the motor unit. In essence, the plate and housing cannot be immersibly cleaned because the fan and motor cannot be detached from the housing without dis-assembly. Further, this unit appears to have a heavy duty motor located underneath the thawing plate and may derive significant heat value from the motor. In addition, this unit also appears to be a heavy stationary unit, and not portable. The Seiichiro unit appears to be specific for restaurant use and does not have any ability to break down and stow in a smaller size configuration.

What is needed is a thaw plate which optimizes the thawing process, and prevents the cold spot and pool of cold air from below the thaw plate. It would also be helpful if the thawing process could be better controlled and have some indication that a proper, and complete thaw has occurred. The needed thaw plate should be portable in order to have the ability to place it near a variety of ambient air sources, as well as differing light (solar for example) conditions. The needed thaw plate should be quickly deployable and synergistically stowable. The needed thaw plate should not represent a significant displacement of space in the food preparation area.

### SUMMARY OF THE INVENTION

A thaw plate is proposed in which air is made to flow underneath a thermal conduction plate in a manner that will cause thawing to occur. In a first embodiment a battery powered fan will cool the bottom of a thaw plate. The use of a fan to cause air to sweep across the bottom of the conduction plate will insure that enough flow will be present that the plate will not sweat or freeze. The utilization of gently forced air will speed up thawing, while providing the ability to begin thawing more closely in time to the beginning of cooking. Further, where a thermal ink is utilized, either on all or a portion of the thermal transmission plate on which the thawing food rests, the food preparer can monitor the thawing process along with other food preparation activities. The motorized blower is also effective in preventing cold air from pooling underneath a thaw plate by insuring a continuous stream of ambient air underneath the thaw plate. In this way there is a continuous supply of heat energy, and possibly humidity absorption, and there is also some turbulence that improves the rate of heat transfer from the air into the aluminum plate.

Further, the thaw place of the invention is ideal for out of doors use, and especially for use in association with food preparation in locations without a source of electricity. As such, the cold plate of the invention can be used out doors in conjunction with grilling and the like. The battery operated nature of the cold plate enables an even greater level of flexibility in that it can be located to affect its operation. A food preparer thawing steaks, and depending upon the time available, can place the cold plate indoors, out of doors in the shade or out of doors in the sun. Further, where available, the cold plate can be positioned in areas with a higher or lower ambient temperature. As an example, a higher temperature location might be near a piece of equipment outputting a warm air stream, and a colder temperature location might be in an air conditioned house or cooler room.

In another embodiment, an air density chimney will be used to passively create a stream of air which will sweep a thermal conduction plate to enhance the thawing process. The amount of air flow will depend upon the difference in temperature and thus density of the ambient air and the temperature of the heat transfer plate. Other variables include the size of a down comer density drive chimney and the overall size of the unit. By channeling the cold air into a chimney or duct having at least some vertical component, the cold air sinks and reduces the pressure below the thaw plate. As a consequence warmer ambient air is drawn horizontal underneath the thaw plate, is cooled due to heat flow into the thaw plate and then continues to flow into the chimney and downwards as a continuous process until all temperatures are the same. This process requires no external energy.

Both embodiments will preferably use a thermochromic ink to visually indicate a change in temperature over a range that will indicate (a) the completion of thawing, and (b) a temperature beyond which thawing should have occurred so that the user can take appropriate action. Such appropriate action might include cooking the food differently or at a high heat to help insure that any bacteria or negative effects of over thawing are neutralized. In the alternative, the food preparer might conclude that the food had simply spend too much time at room temperature and discard it.

This passively operated cold plate device can be located over and adjacent the edge of a sink to allow the chimney some depth as well as possibly being configured allowing thawed juice to drip into the sink. Alternatively the whole assembly could be raised up, such as with folding legs, so that the chimney drops down to a counter top level. The lower ends of the legs can be fixed with soft anti-slipping members.

Another advantage of the invention is the de-couple ability of the cold plate such that the air blowing unit is removable from engagement with the cold plate. This gives the advantages of reduced cost in not having to provide for a completely immersible unit, a better ability to clean the unit. Without separability, a motor unit could become soiled if juices from meat or other thawing foods runs into it. Whilst motor units can be waterproofed, this added expense is prohibitive in the ability to provide the advantage of a low cost product.

A further way to reduce the cost of the product is to utilize any flat surface as the wall which lies opposite the heat transfer plate in order to provide a ducted passage through which the air flows. The tray sits on a flat surface to create a slight gap for the blower to blow air underneath the tray and out through an exhaust gap on the opposite edge for air to exit. The thawing food support tray also preferably may have a detail to catch drips all the way around and may also have a slight incline so that juices on the aluminum plate, should they collect, will flow away from the blower unit. An optional cover may also supplied to allow the user to cover the food being thawed and thereby keep flying insects and airborne contaminants off the food as it thaws, an especially useful feature for use out of doors. A cover shown can preferably fit beneath the tray for compact storage and shipping. For cleaning, the blower unit is simply removed and the tray, cover and aluminum plate can be immersed for washing.

### BRIEF DESCRIPTION OF THE DRAWINGS

The invention, its configuration, construction, and operation will be best further described in the following detailed description, taken in conjunction with the accompanying drawings in which:

FIG. 1 is a view looking into the inventive thaw plate system of the invention shown with four portions of food masses in thawing position;

FIG. 2 is an exploded view of the thaw plate system of FIG. 1 and illustrating the supported nature of a thermally transmissive metal plate supported within a plate support tray, and with the clear combination cover and storage support tray also shown;

FIG. 3 is a sectional view taken along line 3-3 of FIG. 1 and illustrating further details of the internal construction of the thaw plate system;

FIG. 4 is a semi transparent view of the motor unit showing the button, motor, fan and batteries, as wall as a projecting exhaust duct which interfits or fits through the inlet opening of the plate support tray;

FIG. 5 is a bottom view which illustrates the manner in which the motor unit 23 fits adjacent the motor unit 23;

FIG. 6 is a second embodiment of a thaw plate system which uses a down chimney to create a downward gradient of cool air to pull warmer air into an annular plate where it can be used to thaw a food mass; and

FIG. 7 is a perspective view of the underside of FIG. 6 with a bottom section of the annular plate broken away to illustrate an annular insertion of a down chimney into the annular plate, as well as heat fins underneath the annular conduit forming the structure upon which the thawing food rests.

### DETAILED DESCRIPTION OF THE PREFERRED EMBODIMENT

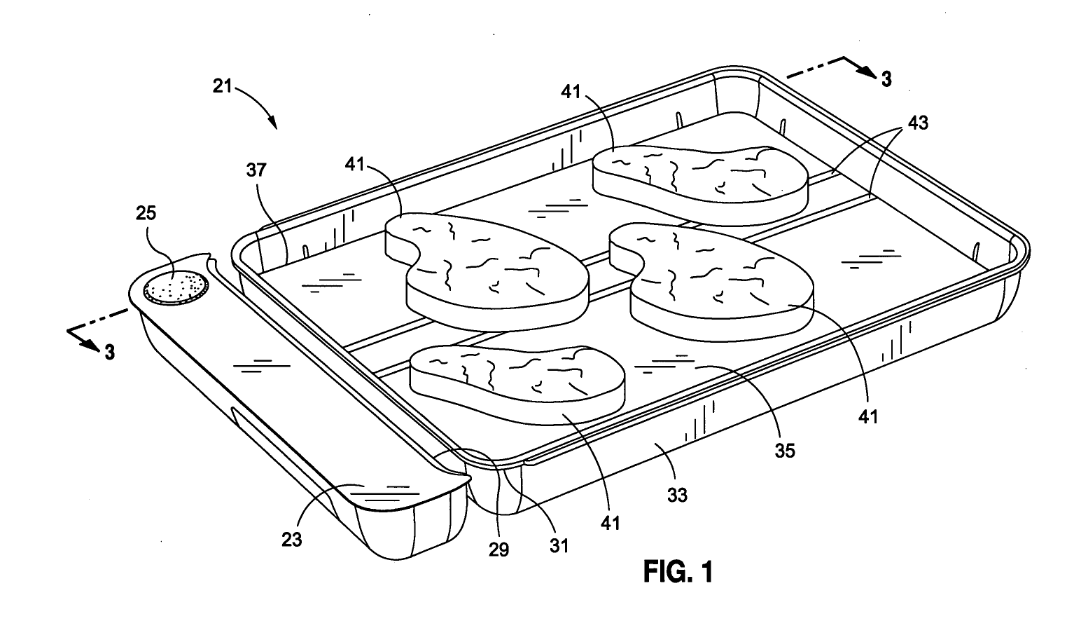

The description and operation of the thaw plate system 21 of the invention will be best described with reference to FIG. 1 which illustrates the assembled and operational thaw plate system 21 but without the cover (not shown) for clarity. The thaw plate system 21 includes a motor unit 23 shown partially spaced apart from the other structure to the right, and having an on/off button 25. The motor unit includes a concave curved portion 29 which mates with an edge and opposite convex curved portion 31 of a plate support tray 33. The number 33 is pointing at the outer wall of an overall “U” cross sectional shape of each side (as will be shown). The plate support tray 33 includes a thermally transmissive metal plate 35 which is preferably supported at an angle, having an upper end 37 showing a lesser height of plate support tray 33 above it, to a lower end 39 showing a greater height of plate support tray 33 above it.

Shown supported by the thermally transmissive metal plate 35 is a set of four meat cuts as being representative of four thawing food masses 41. The thermally transmissive metal plate 35 may include a color change portion 43 which may provide a visual indication of the thaw temperature of the thermally transmissive metal plate 35, and thus the thaw temperature of the four thawing food masses 41. Because a temperature gradient across the area of the plate is not high, and because the thawing process occurs slowly, the temperature across the whole of the plate will have an even temperature. The color change portion 43 may assume a slightly different shade of color nearer or farther away from the four thawing food masses 39, but will be able to indicate a color associated with complete thawing.

As can be seen, the tilt of the thermally transmissive metal plate 35 will cause any liquids on the thermally transmissive metal plate 35 such as residue from melting food, oil or melting of attached ice, to flow away from the motor unit 23. As will be further shown, the structure which supports thermally transmissive metal plate 35 is a “U” shaped channel which extends about the inner periphery of the plate support tray 33 with the channel shape not only lending strength to plate support tray 33, but forming a reservoir which, when the plate support tray 33 is placed on a flat surface, will only leak if completely filled, away from the motor unit 23.

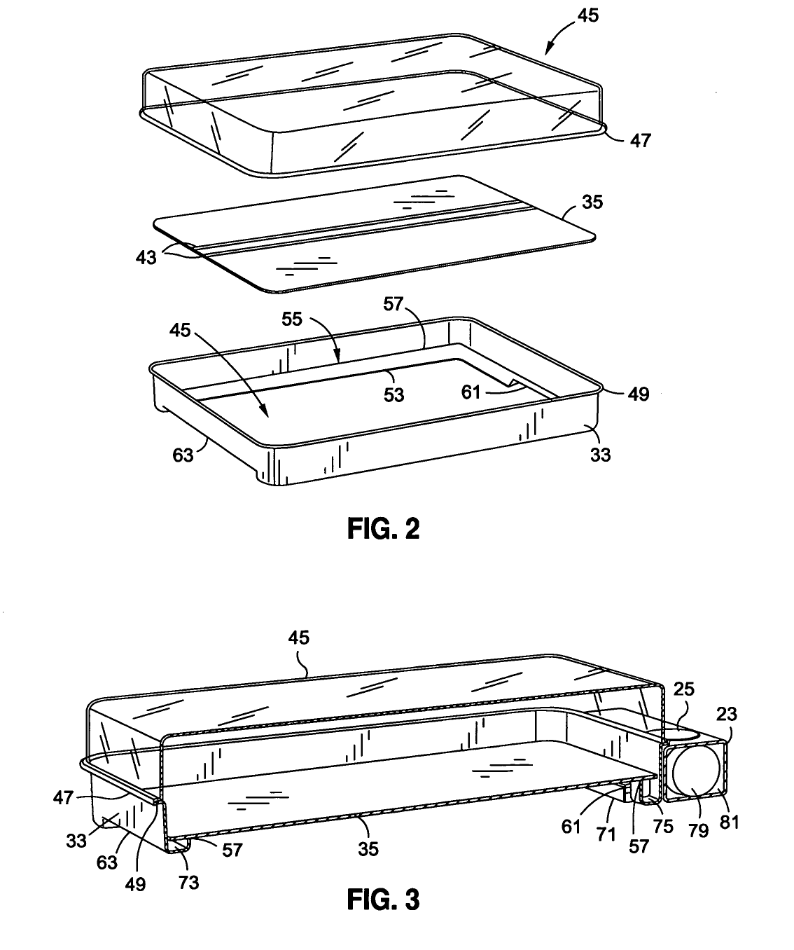

Referring to FIG. 2, an exploded view of the thawing mass support structures, including plate support tray 33 thermally transmissive metal plate 35 are shown with a combination cover and storage support tray 45. Combination cover and storage support tray 45 may have an edge 47 which has a greater outer dimension and at an angle so that it can mate with flared edge 49 of the plate support tray 33. The combination cover and storage support tray 45 and the plate support tray 33 may be made of clear or colored polypropylene plastic. It is preferable for the combination cover and storage support tray 45 to be made of clear material so that a user can view the color change portion 43 while thawing occurs. The combination cover and storage support tray 45 is also important for outdoor use in that it keeps debris and insects away from the food masses 41 and any moisture within the plate support tray 33. In addition, where the thaw plate system 21 operates under direct sunlight, the combination cover and storage support tray 45 produces a greenhouse effect. Further where the thermally transmissive metal plate 35 is black and where the thaw plate system 21 operates under direct sunlight, the system to provide ambient air for warming may reverse and the operation of air movement may act to cool the plate and temper the thawing rate.

FIG. 2 shows that the thermally transmissive metal plate 35 may be nothing more than a flat plate, and that the thermal change portions 43 can be limited in area to both limit the amount of area which may be non-black, and to give a good thermal profile in a longitudinal length of the plate to give a better idea of the thermal gradient along the same length of the thaw plate system 21 as the air flows.

The plate support tray 33 has a number of features. As can be seen, the plate support tray 33 has a through opening 51, which shows that its general overall extent has the shape of an open ring. There is a channel 53 which extends nearly completely around its inner perimeter and having an upwardly disposed opening 55 into which moisture may enter and pool. The channel 53 has an inner wall 57 which becomes vertically taller at one end of the plate support tray 33 and becomes vertically shorter at the other end of the plate support tray 33 so that the thermally transmissive metal plate 35 will be tilted. The result is a channel 53 which as significant depth at one end and slightly shallower depth at the other end.

Also seen is an inlet opening 61 of the plate support 33 which may, but is seen as not extending the width of the plate support tray 33. An exit opening 63 of the plate support tray 33 is seen as opening generally just short of the size of the width of the plate support tray 33. Introduction of air over a relatively shorter width while allowing the air to escape over a longer width (assuming the same height) helps to prevent a pressure drop bottleneck in air flow. In addition, a user will become aware of the area under the thermally transmissive metal plate 35 which will experience the highest air flow.

The inlet opening 61 interrupts the depth of the channel 53 causing it to be high and shallow to accommodate the inlet opening 61. As can be seen, the depth of the flared edge 49 is generally even with the surface upon which the plate support tray 33 sits. Also seen is that the combination cover and storage support tray 45 has an even depth matching the plate support tray, which means that the combination cover and storage support tray 45 can fit securely over the plate support tray 33 to form an expanded internal volume, or the plate support tray 33 fit within an upturned combination cover and storage support tray 45 to assume a storage configuration. Given that the motor unit 23 is slightly lower in height than the plate support tray 33, and that the plate support tray 33 contains a through opening 51, the employment of the upturned combination cover and storage support tray 45 underneath the plate support tray 33 will make a sufficient clearance that the motor unit 23 will fit within for storage with nothing protruding above what would be an upper edge 47 once the combination cover and storage support tray 45 would be inverted.

The exploded view of FIG. 2 is not a view of components which are attached permanently but which are simply placed passively on top of one another. As a result, the disassembly for cleaning is a simple matter. The thermally transmissive metal plate 35 simply lifts out of the plate support tray 33 for washing and storage. The channel 53 which opens upwardly can be easily washed and cleaned with the end of a rag or cloth. Note that the plate support tray 33 has no sharp edges or corners and all surfaces are easily accessible for wiping. The thermally transmissive metal plate 35 is similarly as easily cleanable.

Referring to FIG. 3, a section taken along line 3-3 of FIG. 1 illustrates a more detailed view of the details of both the plate support tray 33, combination cover and storage support tray 45 and how the thermally transmissive metal plate 35 interacts with the inner wall 57 of the channel 53 to attain the tilt previously mentioned and shown. As can be seen the inner wall 57 is relatively high at a position near the motor unit 23, while the inner wall is relatively short at the end opposite motor unit 23. Also seen is an exhaust duct 71 of the motor unit 23 protruding through the inlet opening 61. Also seen is that the exhaust duct 71 and the bottom of the channel 53 are in a position to both gather support from a surface upon which the thaw plate system 21 rests, and to interfit freely.

The thermally transmissive metal plate 35 is seen to extend generally up to the vertical outside walls of the plate support tray 33. As such, when looking into plate support tray 33, it appears as if thermally transmissive metal plate 35 is simply on a tilt and that the interface between the thermally transmissive metal plate 35 and plate support tray 33 is almost seamless. A small clearance between the thermally transmissive metal plate 35 and plate support tray 33 allows any liquids to flow into a shorter end channel 73. A taller end channel 75 is also seen. The shorter height end channel 73 and a taller end channel 75 both rest immediately adjacent the support surface supporting the thaw plate system 21. This means that the volume of entrained liquid which can exist in the channel 53 is based on the width of the channel 53, but upon the height of only the shorter end channel 75.

It is understood that the channel 53 can be wider which would make through opening 51 smaller for a given size of outer perimeter of the plate support tray 33. In such a design, the capacity of the plate support tray 33 for collecting drainage fluids would be enhanced. Similarly, a plate support tray 33 with a higher inner wall 57 such that shorter height end channel 73 would be taller, would also add volume capacity for collection of any drainage fluids. Shorter height end channel 73 would be deeper, but for the provision of the inlet opening 61. A taller plate support tray 33 could still involve an exit opening 63 of the same type.

At the right of FIG. 3 is seen a section of motor unit 23. A section of a motor 79 is seen as resting within a space 81 within the motor unit 23. It is understood that the size, shape and cross sectional area of the inlet opening 61 and exit opening 63 can be varied.

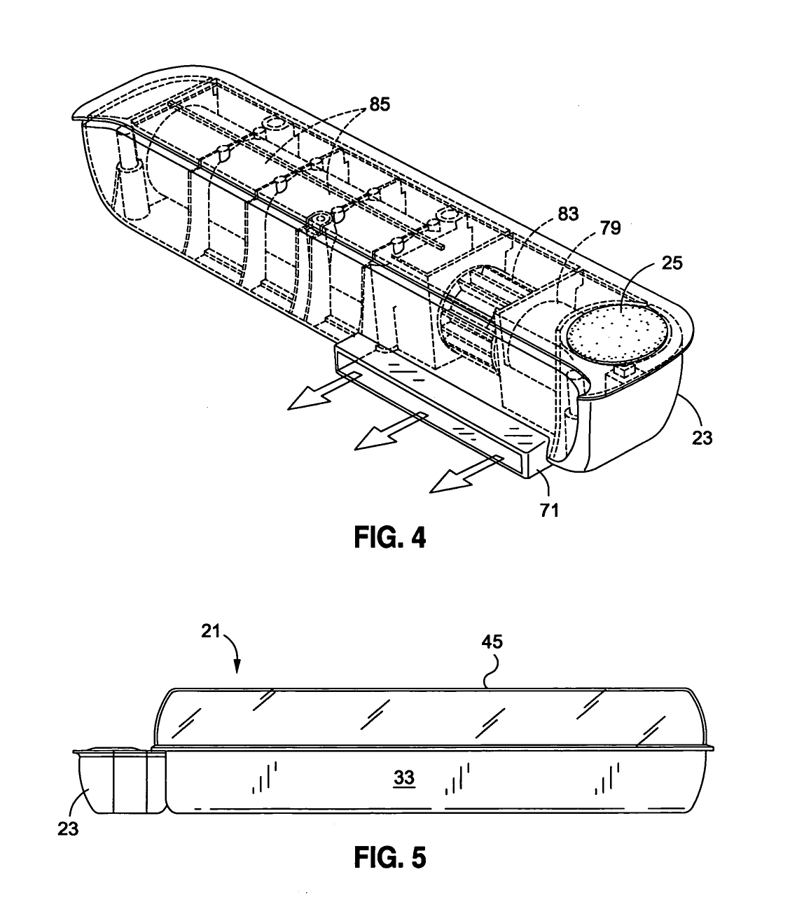

Referring to FIG. 4, a semi transparent view of the motor unit 23 is seen. A radial fan 83 is seen adjacent the motor 79. Beyond the radial fan 83 is a set of batteries 85. As can be imagined from the weight of the batteries 85, motor 79 and fan 83, the motor unit 23 has enough weight to have stable support. Further, when a thawing food mass 41 is loaded onto the thermally transmissive metal plate 35, the weight of the assembly supported by the plate support tray 33 will also be stable. Thus the thaw plate system 21 will have substantial stable weight when operating, and yet the components supported by the plate support tray 33 are extremely light weight without the presence of the food mass 41. In addition, any cooperating structures can be added between the exhaust duct 71 and the inlet opening 61 where it is desired to make a better or more stable connection.

Referring to FIG. 5, a view looking into the interface between the motor unit 23 and the plate support tray 33 illustrates the profile formed between these two components, as well as the approximately doubled height of the combination cover and storage support tray 45 formed with respect to the plate support tray 33. The details of interfit of the combination cover and storage support tray 45 are also seen.

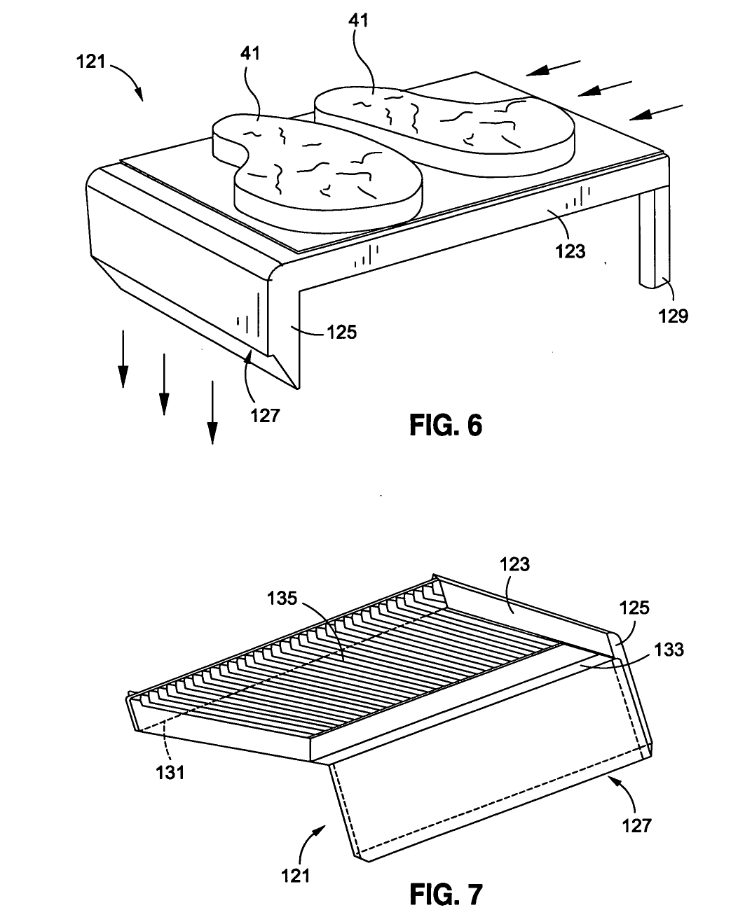

Referring to FIG. 6, a non-motorized thaw plate system 121 is shown as having an annularly shaped metal horizontal thermally conductive support 123, which may preferably be made of aluminum, and an annularly shaped down chimney 125 attached to the annularly shaped metal horizontal thermally conductive support 123. The annularly shaped metal horizontal thermally conductive support 123 and down chimney 125 form an annular connection to make a right angled annular assembly such that air entering the annularly shaped metal horizontal thermally conductive support 123 will flow through it and enter the down chimney 125 to exit at the bottom of the down chimney 125 which has a lower slant opening 127. Atop the annularly shaped metal horizontal thermally conductive support 123 are shown food masses 41 which may be meat or other frozen food. An optional leg or pair of legs, with a single leg 129 being shown, can support the annularly shaped metal horizontal thermally conductive support 123 at its air inlet side where support from an edge of a table or other support cannot be easily or practically utilized.

Air entering the annularly shaped metal horizontal thermally conductive support 123 is cooled by the food masses 41 acting to absorb heat from the inlet air. The cooled, denser air seeks a lower level and exits through the bottom of the down chimney 125 at the lower slant opening 127. This action in turn draws in fresh, warm air into the annularly shaped metal horizontal thermally conductive support 123 and continues until steady state is achieved. As the food masses 41 begin to thaw and their temperature rises, less heat will be withdrawn from the air entering the annularly shaped metal horizontal thermally conductive support 123, and less force will be derived from the down chimney 125, and the overall air flow rate will slow as thawing occurs.

The slant opening 127, along with a leg or legs 129 enables the thaw plate system 121 to be used on a flat surface which raises the annularly shaped metal horizontal thermally conductive support 123 and allows the lower edge of the slant opening 127 to support the thaw plate system 121 without blocking the outlet of the down chimney 125. In cases where a counter top edge is available, the leg or legs 129 need not be attached, and the whole thaw plate system 121 can be supported by a table or counter top with the down chimney 125 extending downwardly from the edge of the table or counter. Further, the leg or legs 129 may have clips to fit partially within the air inlet of the annularly shaped metal horizontal thermally conductive support 123.

Referring to FIG. 7, an underside view of the thaw plate system 121 is shown with a bottom portion 131 of the annularly shaped metal horizontal thermally conductive support 123 removed to expose an insert member 133 of the down chimney 125 which is inserted into the annularly shaped metal horizontal thermally conductive support 123 to make a stable structure and to provide fluid connection between the annularly shaped metal horizontal thermally conductive support 123 and down chimney 125, and to provide easy insertion and removal of the down chimney for slight break down and disassembly for storage. Also seen is a dashed line representing the upper edge of the lower opening 131 of the down chimney 125 which was seen in FIG. 6. Also seen are fins 135 which extend from the underside of the thaw plate portion (upper surface).

While the present invention has been described in terms of a thawing system for enabling safe even thawing of any food mass, and which includes both powered and non powered versions, one skilled in the art will realize that the structure and techniques of the present invention can be applied to many structures and devices which employ warming while utilizing ambient heat.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A thaw plate system comprising:
a plate support tray having a bottom and a top, an inlet opening and an exhaust outlet;
a metal plate supported by the plate support, the metal plate when supported by the metal plate support having a first side in fluid communication with the inlet opening and the exhaust outlet, and a second side for contacting a mass of food to be defrosted;
a motor unit having an air exhaust in alignment with the inlet opening of the plate support tray.

2. The thaw plate system as recited in claim 1 wherein the inlet opening is an indention in a bottom surface of the plate support tray.

3. The thaw plate system as recited in claim 1 wherein the exhaust outlet opening is an indention in a bottom surface of the plate support tray.

4. The thaw plate system as recited in claim 1 wherein the motor unit further comprises:
a motor unit housing having an exhaust and an inlet, the exhaust alignable with the plate support inlet opening;
a switch supported by the motor unit housing;
at least one battery supported within the motor unit housing;
a motor supported within the motor unit housing; and
a fan which is mechanically powered by the motor.

5. The thaw plate system as recited in claim 1 wherein the plate support tray has a through opening.

6. The thaw plate system as recited in claim 1 wherein the plate support has sides and where the cross sectional shape of the sides includes a “U” shaped channel having an outer wall and an inner wall, the inner wall supporting the metal plate.

7. The thaw plate system as recited in claim 6 wherein the inner wall supporting the metal plate is angled to cause the metal plate tilt downwardly toward a side of the plate support tray toward the exhaust outlet.

8. The thaw plate system as recited in claim 6 wherein the inner wall supporting the metal plate is angled to cause the metal plate tilt upwardly away from a side of the plate support tray toward the exhaust outlet.

9. A thaw plate system comprising:
an annular shaped metal horizontal thermally conductive support having a first end and a second end, and a first side as a thaw plate for supporting a mass of food to be thawed and a second side;
an annular shaped down chimney having a first end in fluid communication with the second end of the annular shaped metal horizontal thermally conductive support, and a second end lower than the first end of the annular shaped down chimney, such that thermal energy removed from a fluid within the annular shaped metal horizontal thermally conductive support will flow downwardly through the annular shaped down chimney from the first end of the annular shaped down chimney to the second end of the annular shaped down chimney to pull ambient air into the first end of the annular shaped metal horizontal thermally conductive support to provide a fresh supply of air for cooling by the mass of food to be thawed.

10. The thaw plate system as recited in claim 9 in which the first side of the annular shaped metal horizontal thermally conductive support has an internal surface opposite the first side and having heat fins.

11. The thaw plate system as recited in claim 9 and further comprising a leg attached to the annular shaped metal horizontal thermally conductive support.
